(19) United States
(12) Patent Application Publication
(10) Pub. No.: US 2020/0081311 A1
(43) Pub. Date: Mar. 12, 2020

(54) ELECTROCHROMIC DEVICE

(71) Applicant: Electronics and Telecommunications Research Institute, Daejeon (KR)

(72) Inventors: Chil Seong AH, Daejeon (KR); Hojun RYU, Seoul (KR); Juhee SONG, Daejeon (KR); Tae-Youb KIM, Daejeon (KR); Chi-Sun HWANG, Daejeon (KR)

(73) Assignee: Electronics and Telecommunications Research Institute, Daejeon (KR)

(21) Appl. No.: 16/559,769

(22) Filed: Sep. 4, 2019

(30) Foreign Application Priority Data
Sep. 7, 2018 (KR) 10-2018-0107397

(51) Int. Cl. G02F 1/1523; G02F 1/155; G02F 1/163; G02F 1/1516; C09B 21/00

(52) U.S. Cl. CPC G02F 1/1525; G02F 1/155; G02F 2202/36; G02F 1/15165; C09B 21/00; G02F 1/163

(57) ABSTRACT

An electrochromic device according to the inventive concept includes a first electrode; a second electrode on the first electrode; and an electrochromic electrolyte layer and a nanostructure between the first and second electrodes. The nanostructure has a porous structure, and the electrochromic electrolyte layer includes phenothiazine or a compound represented by the following Formula 1:

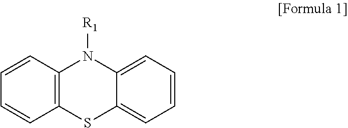

where R₁ is hydrogen, C1-C6 alkyl or phenyl.

### CROSS-REFERENCE TO RELATED APPLICATIONS

This U.S. non-provisional patent application claims priority under 35 U.S.C. § 119 of Korean Patent Application No. 10-2018-0107397, filed on Sep. 7, 2018, the entire contents of which are hereby incorporated by reference.

### BACKGROUND

The present disclosure herein relates to an electrochromic device. More particularly, the present disclosure herein relates to an electrochromic device having excellent electrochromic properties.

Electrochromism means a phenomenon where an electrochromic material is reversibly colored or decolorized by the oxidation or reduction reaction of the electrochromic material. An electrochromic device may include a material which is colored by accepting electrons (i.e., through reduction reaction) or donating electrons (i.e., through oxidation reaction). The electrochromic device is a non-self-emission type display device, which uses an external light source, and has good visibility in outdoors and a high contrast ratio under strong light. In addition, since the control of transmittance by a driving voltage is easy, a driving voltage is low, and a view angle is wide, the electrochromic device is widely studied in various fields.

### SUMMARY

The present disclosure provides an electrochromic device having excellent electrochromic properties.

An embodiment of the inventive concept provides an electrochromic device including a first electrode; a second electrode on the first electrode; and an electrochromic electrolyte layer and a nanostructure between the first and second electrodes, wherein the nanostructure has a porous structure, and the electrochromic electrolyte layer includes phenothiazine or a compound represented by the following Formula 1:

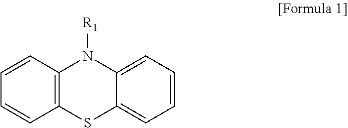

where R₁ is hydrogen, C1-C6 alkyl or phenyl.

In an embodiment, the electrochromic device may further include a pore in the nanostructure, and the pore may be filled with the same material included in the electrochromic electrolyte layer.

In an embodiment, the compound of Formula 1 may be one of 10-ethylphenothiazine, 10-isopropylphenothiazine, or 10-phenylphenothiazine.

In an embodiment, the electrochromic electrolyte layer may further include a polymer, a solvent and a reaction inducing material, and the reaction inducing material may include at least one of ferrocene, iodides, imidazole, 1,3,5-tricyanobenzene (TCB), tetracyanoquinodimethane (TCNQ), or ferrocene derivatives.

In an embodiment, the polymer may include at least one of poly(ethylene glycol) (PEG), poly methyl methacrylate (PMMA), poly butyl acrylate (PBA), poly vinyl butyrate (PVB), polyvinyl alcohol (PVA), poly(ethylene oxide) (PEO), poly(propylene oxide) (PPO), poly acrylonitrile (PAN), poly(vinylidene fluoride) (PVDF), or poly(vinylidene fluoride-co-hexafluoropropylene) (PVDF-HFP).

In an embodiment, the solvent may include at least one of propylene carbonate (PC), butylene carbonate (BC), ethylene carbonate (EC), gamma-butyrolactone (gamma-BL), gamma-VL, NMO, dimethyl carbonate (DMC), diethyl carbonate (DEC), ethyl methyl carbonate (EMC), propyl methyl carbonate (PMC), ethyl acetate (EA), water (H₂O), ethylene blue (EB) or methylene blue (MB).

In an embodiment, the electrochromic electrolyte layer may further include a lithium ion producing material, and the lithium ion producing material may include at least one of lithium perchlorate (LiClO₄), LiBF₄, LiPF₆, LiAsF₆, lithium triflate (LiTf, LiCF₃SO₃), lithium imdide (LiIm, Li[N(SO₂CF₃)₂]), LiBeTi (Li[N(SO₂CF₂CF₃)₂]), LiBr, or LiI.

In an embodiment, the electrochromic electrolyte layer may further include a hydrogen ion producing material, and the hydrogen ion producing material may include at least one of hydrochloric acid (HCl), sulfuric acid (H₂SO₄), nitric acid (HNO₃), phosphoric acid (H₃PO₄), acetic acid (CH₃COOH), perchloric acid (HClO₄) or formic acid (HCOOH).

In an embodiment of the inventive concept, an electrochromic device includes a first electrode; a second electrode on the first electrode; and an electrochromic layer, an electrolyte layer and a nanostructure between the first and the second electrodes, wherein the nanostructure has a porous structure, and the electrochromic layer includes Prussian blue or PEDOT:PSS.

In an embodiment, the electrochromic layer and the nanostructure may be separated by the electrolyte layer.

In an embodiment, the electrochromic device may further include a pore in the nanostructure, and the pore may be filled with the same material included in the electrolyte layer.

In an embodiment, the electrolyte layer may include a polymer and a solvent.

In an embodiment, the electrolyte layer may further include a lithium ion producing material, and the lithium ion producing material may include at least one of lithium perchlorate (LiClO₄), LiBF₄, LiPF₆, LiAsF₆, lithium triflate (LiTf, LiCF₃SO₃), lithium imdide (LiIm, Li[N(SO₂CF₃)₂]), LiBeTi (Li[N(SO₂CF₂CF₃)₂]), LiBr, or LiI.

In an embodiment, the electrolyte layer may further include a hydrogen ion producing material, and the hydrogen ion producing material may include at least one of hydrochloric acid (HCl), sulfuric acid (H₂SO₄), nitric acid (HNO₃), phosphoric acid (H₃PO₄), acetic acid (CH₃COOH), perchloric acid (HClO₄) or formic acid (HCOOH).

In an embodiment of the inventive concept, an electrochromic device includes a first substrate; a first electrochromic structure on the first substrate; a second substrate on the first electrochromic structure; a second electrochromic structure on the second substrate; and a third substrate on the second electrochromic structure, wherein the first and second electrochromic structures each includes a first electrode, a second electrode, and a nanostructure between the first and second electrodes, and the nanostructure has a porous structure.

In an embodiment, the first and second electrochromic structures each may further include an electrochromic electrolyte layer on the first electrode, and the electrochromic electrolyte layer may include phenothiazine or a compound represented by the following Formula 1:

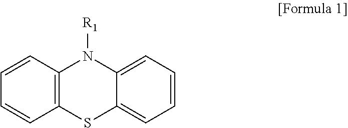

where R₁ is hydrogen, C1-C6 alkyl or phenyl.

In an embodiment, the first and second electrochromic structures each may further include an electrochromic layer on the first electrode and an electrolyte layer on the electrochromic layer, and the electrochromic layer may include Prussian blue or PEDOT:PSS.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1A is a cross-sectional view of an electrochromic device according to embodiments of the inventive concept;

FIG. 1B is an enlarged view of region A in FIG. 1A;

FIG. 2 is a cross-sectional view of an electrochromic device according to embodiments of the inventive concept;

FIG. 3 is a cross-sectional view of an electrochromic device according to embodiments of the inventive concept;

FIG. 4A and FIG. 4B are diagrams for explaining the driving of the electrochromic device according to FIG. 1;

FIG. 5 is a graph showing the transmittance of an electrochromic device according to FIG. 1 of the inventive concept;

FIG. 6 is a cross-sectional view of an electrochromic device according to embodiments of the inventive concept;

FIG. 7 and FIG. 8 are cross-sectional views of electrochromic devices according to embodiments of the inventive concept;

FIG. 9A and FIG. 9B are diagrams for explaining the driving of the electrochromic device according to FIG. 6;

FIG. 10A and FIG. 10B are cross-sectional views of electrochromic devices according to embodiments of the inventive concept;

FIG. 11A is a graph showing the transmittance of an electrochromic device according to FIG. 6;

FIG. 11B is a graph showing the transmittance of an electrochromic device according to FIG. 10A; and

FIG. 12A and FIG. 12B are cross-sectional views of electrochromic devices according to embodiments of the inventive concept.

### DETAILED DESCRIPTION

The advantages and the features of the inventive concept, and methods for attaining them will be described in example embodiments below with reference to the accompanying drawings. The inventive concept may, however, be embodied in different forms and should not be construed as limited to the embodiments set forth herein. Rather, these embodiments are provided so that this description will be thorough and complete, and will fully convey the scope of the present inventive concept to those skilled in the art. Like numbers refer to like elements throughout.

The terminology used herein is for the purpose of describing particular example embodiments only and is not intended to limit the present inventive concept. As used herein, the singular forms are intended to include the plural forms as well, unless the context clearly indicates otherwise. It will be further understood that the terms “comprises” and/or “comprising,” when used in this specification, specify the presence of stated features, steps, operations, and/or devices, but do not preclude the presence or addition of one or more other features, steps, operations, and/or devices thereof. Hereinafter, embodiments of the inventive concept will be explained in detail.

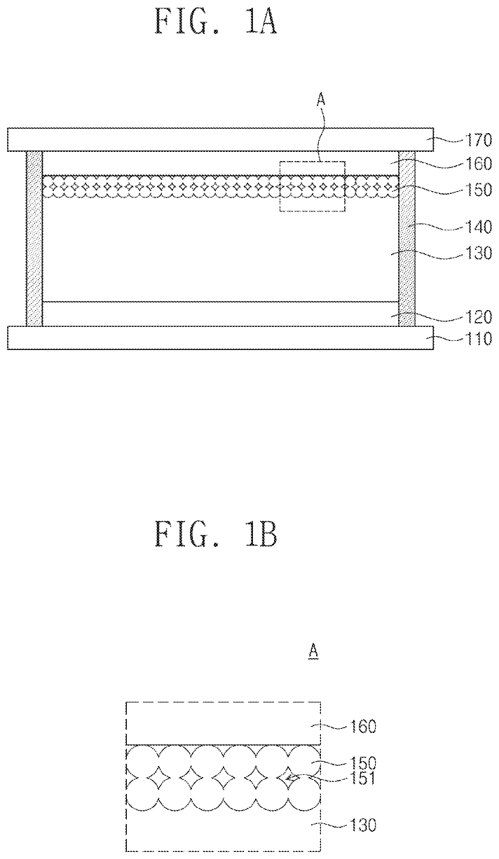

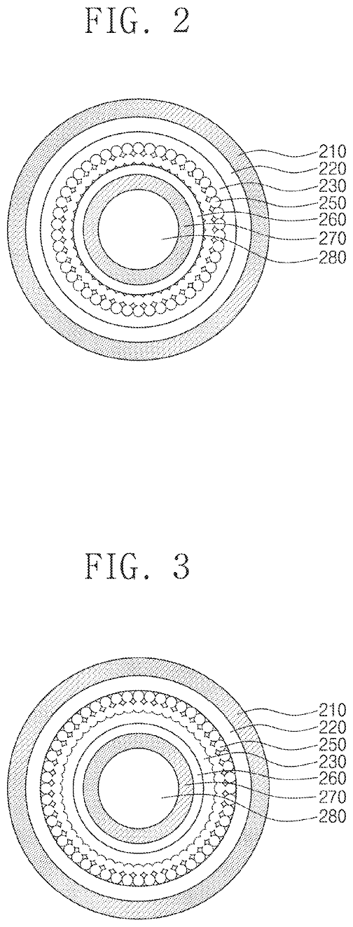

FIG. 1A is a cross-sectional view of an electrochromic device according to embodiments of the inventive concept. FIG. 1B is an enlarged view of region A in FIG. 1A.

Referring to FIG. 1A and FIG. 1B, the electrochromic device according to the inventive concept may include a first substrate 110, a first electrode layer 120, an electrochromic electrolyte layer 130, a nanostructure 150, a second electrode layer 160, a second substrate 170 and a sealing part 140.

On the first substrate 110, the first electrode layer 120 may be provided. The first substrate 110 may be transparent. The first substrate 110 may include glass, plastic or a flexible polymer film. For example, the flexible polymer film may include one of poly(ethylene glycol) (PEG), polyethylene (PE), polyvinyl chloride (PVC), polypropylene (PP), polyolefin (PO), polyvinyl alcohol (PVA), polyurethane (PU), nylon, polycarbonate (PC), polyester, polyacrylonitrile (PAN), polyacetal (POM), polytetrafluoroethylene (PTFE), fluorinated ethylene propylene (FEP), cyclic polyolefin (COP), modified PPO (MPPO), polyethylene terephthalate (PET), polycarbonate (PC), an acrylonitrile-butadiene-styrene copolymer (ABS), polymethyl methacrylate (PMMA), polyethylene naphthalate (PEN), polyether sulfone (PES), cyclic olefin copolymer (COC), a triacetylcellulose (TAC) film, a polyvinyl alcohol (PVA) film, a polyimide (PI) film, or polystyrene (PS).

The thickness of the first electrode layer 120 may be from about 0.1 nm to about 10 μm. The first electrode layer 120 may include one electrode material layer and a plurality of electrode material layers. For example, the electrode material layer may include one of indium zinc oxide (IZO), indium tin oxide (ITO), fluorine-doped tin oxide (FTO), aluminum-doped zinc oxide (AZO), boron-doped zinc oxide (BZO), tungsten-doped zinc oxide (WZO), tungsten-doped tin oxide (WTO), gallium-doped zinc oxide (GZO), antimony-doped tin oxide (ATO), indium-doped zinc oxide (IZO), niobium (Nb)-doped titanium oxide (TiOx), single or multiple oxide-metal-oxide (OMO), a conductive polymer, a conductive organic molecule, a carbon nanotube, graphene, a silver nanowire, aluminum, silver, ruthenium, gold, platinum, tin, chromium, indium, zinc, copper, rubidium, nickel, ruthenium oxide, rubidium oxide, tin oxide, indium oxide, zinc oxide, chromium oxide or molybdenum. The first electrode layer 120 may be transparent, translucent, or opaque. The first electrode layer 120 may be formed on the first substrate 110 through a vacuum deposition process or a wet coating process.

On the first electrode layer 120, the electrochromic electrolyte layer 130 may be provided. The electrochromic electrolyte layer 130 may be one of liquid, solid, gel or sol.

The electrochromic electrolyte layer 130 may include phenothiazine or phenothiazine derivatives. The phenothiazine derivative may include a compound represented by the following Formula 1:

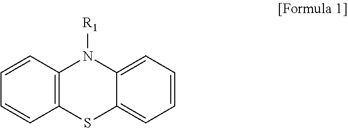

R₁ may be hydrogen, C1-C6 alkyl or phenyl.

In an embodiment, the compound of Formula 1 may be one of 10-ethylphenothiazine, 10-isopropylphenothiazine, or 10-phenylphenothiazine.

In the electrochromic electrolyte layer 130, the amount of the phenothiazine or the phenothiazine derivative may be from about 0.01 wt % to about 50 wt %. The phenothiazine or the phenothiazine derivative may be reversibly discolored according to the application of a voltage. The phenothiazine or the phenothiazine derivative may be discolored from red to a transparent state, or from a transparent state to red.

The electrochromic electrolyte layer 130 may further include a lithium ion or hydrogen ion. If the electrochromic electrolyte layer 130 includes a lithium ion, the lithium ion may be produced through the dissolution of a lithium ion producing material in the electrochromic electrolyte layer 130. In an embodiment, the lithium ion producing material may include at least one of lithium perchlorate (LiClO₄), LiBF₄, LiPF₆, LiAsF₆, lithium triflate (LiTf, LiCF₃SO₃), lithium Imdide (LiIm, Li[N(SO₂CF₃)₂]), LiBeTi (Li[N(SO₂CF₂CF₃)₂]), LiBr or LiI. The concentration of the lithium ion producing material which is dissolved in the electrochromic electrolyte layer 130 may be about 0.001 M to about 10 M, preferably, about 0.02 M to about 1 M. If the electrochromic electrolyte layer 130 includes a hydrogen ion, the hydrogen ion may be produced through the dissolution of a hydrogen ion producing material in the electrochromic electrolyte layer 130. For example, the hydrogen ion producing material may include at least one of hydrochloric acid (HCl), sulfuric acid (H₂SO₄), nitric acid (HNO₃), phosphoric acid (H₃PO₄), acetic acid (CH₃COOH), perchloric acid (HClO₄) or formic acid (HCOOH).

The electrochromic electrolyte layer 130 may further include a polymer. For example, the polymer may include at least one of poly(ethylene glycol) (PEG), poly methyl methacrylate (PMMA), poly butyl acrylate (PBA), poly vinyl butyrate (PVB), polyvinyl alcohol (PVA), poly(ethylene oxide) (PEO), poly(propylene oxide) (PPO), poly acrylonitrile (PAN), poly(vinylidene fluoride) (PVDF), or poly(vinylidene fluoride-co-hexafluoropropylene) (PVDF-HFP). In the electrochromic electrolyte layer 130, the amount of the polymer may be from about 0.001 wt % to about 90 wt %. If the amount of the polymer increases, the viscosity of the electrochromic electrolyte layer 130 may increase.

The electrochromic electrolyte layer 130 may further include a solvent. In an embodiment, the solvent may include at least one of propylene carbonate (PC), butylene carbonate (BC), ethylene carbonate (EC), gamma-butyrolactone (gamma-BL), gamma-VL, NMO, dimethyl carbonate (DMC), diethyl carbonate (DEC), ethyl methyl carbonate (EMC), propyl methyl carbonate (PMC), ethyl acetate (EA), water (H₂O), ethylene blue (EB) or methylene blue (MB).

The electrochromic electrolyte layer 130 may further include a reaction inducing material. The reaction inducing material may play the role of inducing oxidation and reduction reaction in the electrochromic electrolyte layer 130. For example, the reaction inducing material may include at least one of ferrocene, iodides, imidazole, 1,3,5-tricyanobenzene (TCB), tetracyanoquinodimethane (TCNQ), or ferrocene derivatives. In the electrochromic electrolyte layer 130, the concentration of the reaction inducing material may be from about 0.001 mM to about 4,000 mM.

On the electrochromic electrolyte layer 130, the nanostructure 150 may be provided. The nanostructure 150 may include interconnected nanoparticles. The nanostructure 150 may have a porous structure. In other words, a pore 151 may be provided in the nanostructure 150. The pore 151 may be filled with the same material as the material included in the electrochromic electrolyte layer 130. The thickness of the nanostructure 150 may be from about 0.1 nm to about 50 μm, preferably, from about 100 nm to about 10 μm. In an embodiment, the nanoparticle may include at least one among indium zinc oxide (IZO), indium tin oxide (ITO), fluorine-doped tin oxide (FTO), aluminum-doped zinc oxide (AZO), boron-doped zinc oxide (BZO), tungsten-doped zinc oxide (WZO), tungsten-doped tin oxide (WTO), gallium-doped zinc oxide (GZO), antimony-doped tin oxide (ATO), indium-doped zinc oxide (IZO), niobium (Nb)-doped titanium oxide (TiOx), single or multiple oxide-metal-oxide (OMO), a conductive polymer, a conductive organic molecule, a carbon nanotube, graphene, a silver nanowire, aluminum, silver, ruthenium, gold, platinum, tin, chromium, indium, zinc, copper, rubidium, nickel, ruthenium oxide, rubidium oxide, tin oxide, indium oxide, zinc oxide, chromium oxide and molybdenum. The nanostructure 150 may be transparent, translucent, or opaque.

In an embodiment, the nanostructure 150 may be formed through a wet coating process. The wet coating process may include mixing nanoparticles with a solvent to prepare a sol, applying the sol on the second electrode layer 160, and evaporating the solvent. In an embodiment, the solvent may be at least one among ethanol, methanol, isopropyl alcohol, benzene, toluene and tetrahydrofuran (THF).

In another embodiment, the nanostructure 150 may be formed by a vacuum deposition process such as chemical vapor deposition (CVD) and physical vapor deposition (PVD).

On the nanostructure 150, the second electrode layer 160 may be provided. The thickness of the second electrode layer 160 may be from about 0.1 nm to about 10 μm. The shortest distance between the second electrode layer 160 and the first electrode layer 120 may be from about 0.001 μm to about 2,000 μm, preferably, from about 1 μm to about 200 μm. The second electrode layer 160 may include one electrode material layer or a plurality of electrode material layers. The second electrode layer 160 may be transparent, translucent, or opaque. The second electrode layer 160 may be formed through a deposition process on the second substrate 170. The second electrode layer 160 may be a working electrode, and the first electrode layer 120 may be a counter electrode.

On the second electrode layer 160, the second substrate 170 may be provided. The second substrate 170 may be transparent. The second substrate 170 may include glass, plastic or a flexible polymer film.

Between the first and second substrates 110 and 170, a sealing part 140 may be provided. The sealing part 140 may enclose the first electrode layer 120, the electrochromic electrolyte layer 130, the nanostructure 150 and the second electrode layer 160 on a plane. The sealing part 140 may seal so that the first electrode layer 120, the electrochromic electrolyte layer 130, the nanostructure 150 and the second electrode layer 160 may not contact the outside. In an embodiment, the sealing part 140 may include one of a surlyn film, a photocurable material or a thermosetting material. The sealing part 140 may be formed by inserting one of the surlyn film, the photocurable material or the thermosetting material between the first and second substrates 110 and 170, and then heat treating. The heat treatment may be performed at about 115° C. for about 30 seconds.

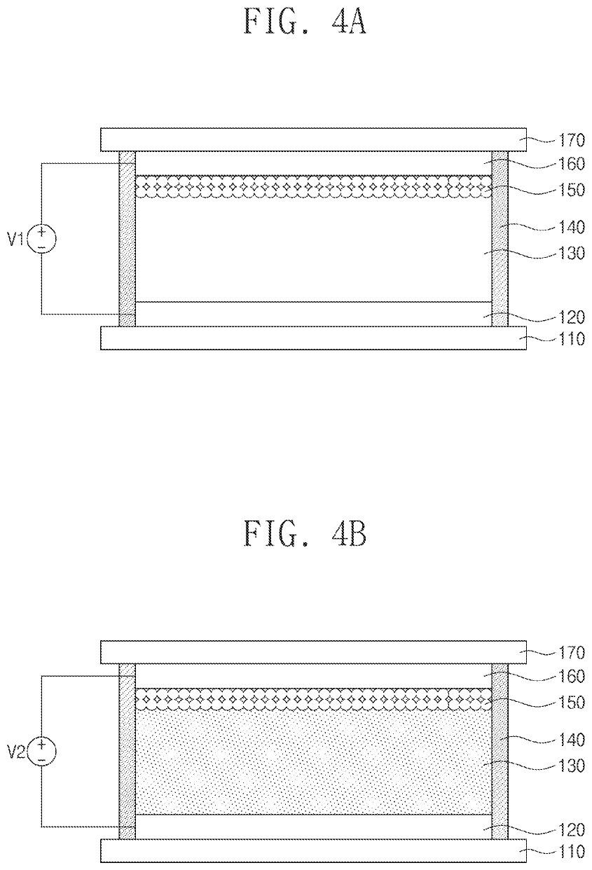

FIG. 2 is a cross-sectional view of an electrochromic device according to embodiments of the inventive concept.

Referring to FIG. 2, the electrochromic device may be provided in a cylinder shape. A support 280 may be provided in the innermost portion of the electrochromic device. In other words, the support 280 may form the core of the electrochromic device.

On the support 280, a first coating 270 may be provided. The first coating 270 may enclose the support 280.

On the first coating 270, the first electrode layer 260 may be provided. The first electrode layer 260 may enclose the first coating 270. The thickness of the first electrode layer 260 may be from about 0.1 nm to about 10 μm. The first electrode layer 260 may include one electrode material layer or a plurality of electrode material layers.

On the first electrode layer 260, the nanostructure 250 may be provided. The nanostructure 250 may enclose the first electrode layer 260. The nanostructure 250 may include interconnected nanoparticles. The nanostructure 250 may have a porous structure. In other words, a pore may be provided in the nanostructure 250.

On the nanostructure 250, the electrochromic electrolyte layer 230 may be provided. The electrochromic electrolyte layer 230 may be enclose the nanostructure 250. The pore of the nanostructure 250 may be filled with the same material included in the electrochromic electrolyte layer 230. The electrochromic electrolyte layer 230 may be one of liquid, solid, gel or sol. The electrochromic electrolyte layer 230 may include phenothiazine or phenothiazine derivatives, a lithium ion or hydrogen ion, a polymer, a solvent, and a reaction inducing material.

On the electrochromic electrolyte layer 230, the second electrode layer 220 may be provided. The second electrode layer 220 may enclose the electrochromic electrolyte layer 230. The thickness of the second electrode layer 220 may be from about 0.1 nm to about 10 μm. The shortest distance between the second electrode layer 220 and the first electrode layer 260 may be from about 0.001 μm to about 2,000 μm, preferably, from about 1 μm to about 200 μm. The second electrode layer 220 may include one electrode material layer or a plurality of electrode material layers.

On the second electrode layer 220, a second coating 210 may be provided. The second coating 210 may enclose the second electrode layer 220. The second coating 210 may play the role of protecting the electrochromic device from the outside.

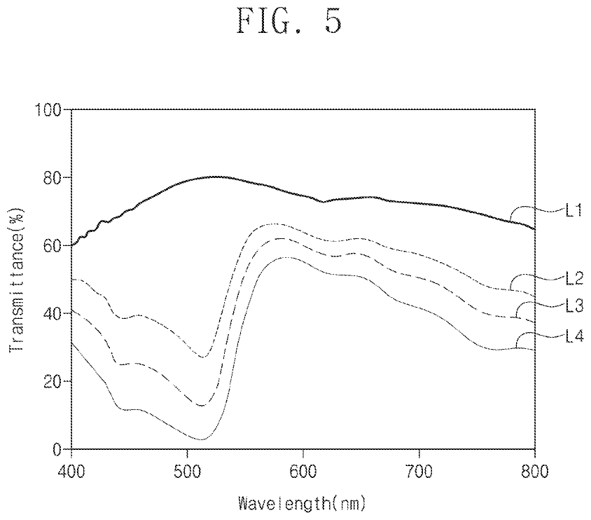

FIG. 3 is a cross-sectional view of an electrochromic device according to embodiments of the inventive concept. Detailed explanation on the technical features which are overlapped with those of the electrochromic device explained referring to FIG. 2 will be omitted, and different features therefrom will be explained in detail.

Referring to FIG. 3, the electrochromic electrolyte layer 230 may be provided on the first electrode layer 260. The electrochromic electrolyte layer 230 may enclose the first electrode layer 260.

On the electrochromic electrolyte layer 230, the nanostructure 250 may be provided. The nanostructure 250 may enclose the electrochromic electrolyte layer 230. The pore of the nanostructure 250 may be filled with the same material as the material included in the electrochromic electrolyte layer 230.

On the nanostructure 250, the second electrode layer 220 may be provided. The second electrode layer 220 may enclose the nanostructure 250.

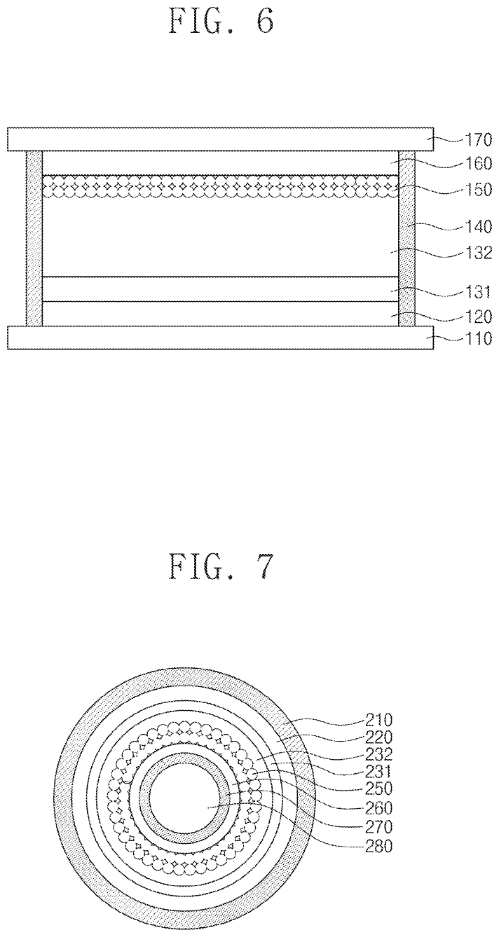

FIG. 4A and FIG. 4B are diagrams for explaining the driving of the electrochromic device according to FIG. 1.

Referring to FIG. 4A, a first voltage V1 may be applied to the first electrode layer 120 and the second electrode layer 160 of the electrochromic device. The first voltage V1 may be a decolorizing voltage. In other words, if the first voltage V1 is applied, the electrochromic device may be decolorized. In an embodiment, the first voltage V1 may be from about 0 V to about 5 V.

By the application of the first voltage V1, the first electrode layer 120, the nanostructure 150 and the second electrode layer 160 may not be discolored in a visible light wavelength region.

By the application of the first voltage V1, the electrochromic electrolyte layer 130 may become transparent. In other words, by the application of the first voltage V1, the transmittance of the electrochromic electrolyte layer 130 may increase. By the application of the first voltage V1, reduction reaction may be carried out in the phenothiazine or phenothiazine derivative in the electrochromic electrolyte layer 130.

If a voltage is not applied to the electrochromic device, similar to the case of applying the first voltage V1 to the electrochromic device, the first electrode layer 120, the nanostructure 150 and the second electrode layer 160 may not be discolored in a visible light wavelength region, and the electrochromic electrolyte layer 130 may become transparent.

Referring to FIG. 4B, to the first electrode layer 120 and the second electrode layer 160 of the electrochromic device, a second voltage V2 may be applied. The second voltage V2 may be a coloring voltage. In other words, if the second voltage V2 is applied, the electrochromic device may be colored. In an embodiment, the second voltage V2 may be from about −0.1 V to about −5 V.

By the application of the second voltage V2, the first electrode layer 120, the nanostructure 150 and the second electrode layer 160 may not be discolored in a visible light wavelength region.

By the application of the second voltage V2, the electrochromic electrolyte layer 130 may be discolored to red. In other words, by the application of the second voltage V2, the transmittance of the electrochromic electrolyte layer 130 may decrease. By the application of the second voltage V2, oxidation reaction may be carried out in the phenothiazine or phenothiazine derivative in the electrochromic electrolyte layer 130.

In the electrochromic device according to the inventive concept, by the application of the second voltage V2, the electrochromic electrolyte layer 130 may be discolored, but the nanostructure 150 may not be discolored in the visible light wavelength region, and thus, electrochromic properties may be excellent.

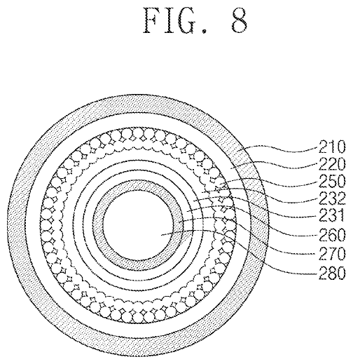

FIG. 5 is a graph showing the transmittance of an electrochromic device according to FIG. 1 of the inventive concept.

FIG. 5 shows the transmittance in accordance with the wavelength for a case where the first and second electrode layers 120 and 160 include indium tin oxide (ITO) having resistance per unit area of about 15 ohm/cm², and the electrochromic electrolyte layer 130 includes about 5 wt % of poly methyl methacrylate (PMMA), about 4 wt % of 10-ethylphenothiazine, about 11.25 mM of ferrocene, about 0.1 M of lithium perchlorate (LiClO₄) and propylene carbonate (PC).

Referring to FIG. 5, the transmittance in accordance with an applied voltage to an electrochromic device may be confirmed. The transmittance in accordance with the wavelength may be confirmed for a case where a voltage of about 0 V is applied to an electrochromic device for about 20 seconds (L1), a case where a voltage of about −1.5 V is applied for about 20 seconds (L2), a case where a voltage of about −1.75 V for about 20 seconds (L3), and a case where a voltage of about −2 V is applied for about 20 seconds (L4).

About −1.5 V, about −1.75 V and about −2 V may be coloring voltages. About 0 V may be a decolorizing voltage. It may be confirmed that if the absolute value of the applied coloring voltage increases, the transmittance of the electrochromic device decreases.

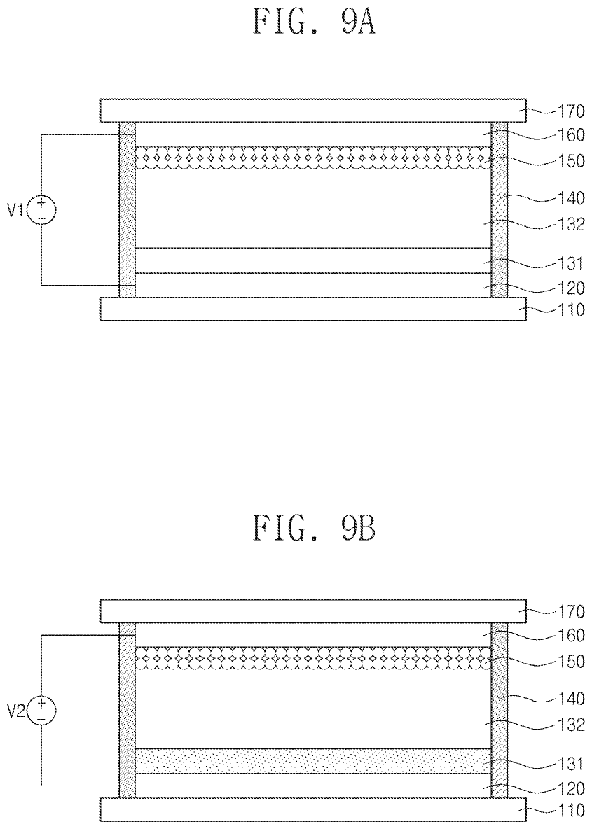

FIG. 6 is a cross-sectional view of an electrochromic device according to embodiments of the inventive concept. Detailed explanation on the technical features which are overlapped with those of the electrochromic device explained referring to FIG. 1A and FIG. 1B will be omitted, and different features therefrom will be explained in detail.

Referring to FIG. 6, on the first electrode layer 120, the electrochromic layer 131 may be provided. The thickness of the electrochromic layer 131 may be from about 0.1 nm to about 100 μm, preferably, from about 100 nm to about 10 μm. The electrochromic layer 131 may include Prussian blue or PEDOT:PSS.

The electrochromic layer 131 may be formed through a dry coating process or a wet coating process. The wet coating process may include mixing Prussian blue or PEDOT:PSS with a solvent and an additive to prepare a sol, applying the sol on the first electrode layer 120, and evaporating the solvent. In an embodiment, the solvent may be at least one among ethanol, methanol, isopropyl alcohol, benzene, toluene and tetrahydrofuran (THF).

On the electrochromic layer 131, the electrolyte layer 132 may be provided. The electrolyte layer 132 may include a lithium ion or hydrogen ion, a polymer and a solvent.

On the electrolyte layer 132, the nanostructure 150 may be provided. The pore of the nanostructure 150 may be filled with the same material as the material included in the electrolyte layer 132.

The electrochromic layer 131 and the nanostructure 150 may be separated by the electrolyte layer 132.

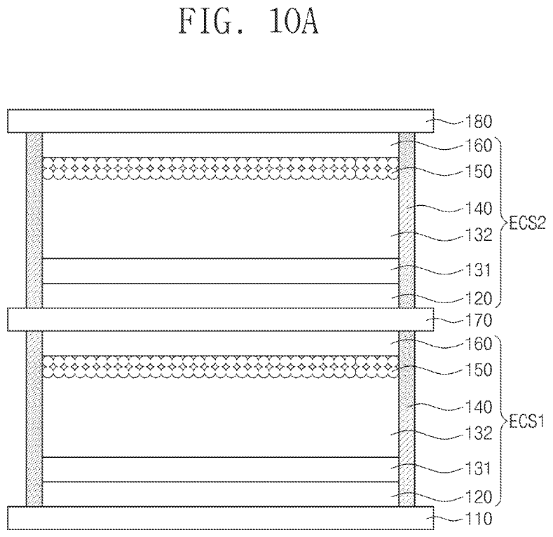

FIG. 7 and FIG. 8 are cross-sectional views of electrochromic devices according to embodiments of the inventive concept. Detailed explanation on the technical features which are overlapped with those of the electrochromic device explained referring to FIG. 2 will be omitted, and different features therefrom will be explained in detail.

Referring to FIG. 7, on a first electrode layer 260, a nanostructure 250 may be provided. The nanostructure 250 may enclose the first electrode layer 260. The pore of the nanostructure 250 may be filled with the same material as the material included in an electrolyte layer 232.

On the nanostructure 250, the electrolyte layer 232 may be provided. The electrolyte layer 232 may enclose the nanostructure 250. The electrolyte layer 232 may include a lithium ion or hydrogen ion, a polymer material and a solvent.

On the electrolyte layer 232, an electrochromic layer 231 may be provided. The thickness of the electrochromic layer 231 may enclose the electrolyte layer 232. The thickness of the electrochromic layer 231 may be from about 0.1 nm to about 100 μm, preferably, from about 100 nm to about 10 μm. The electrochromic layer 231 may include Prussian blue or PEDOT:PSS.

Referring to FIG. 8, on the first electrode layer 260, the electrochromic layer 231 may be provided. The electrochromic layer 231 may enclose the first electrode layer 260. The thickness of the electrochromic layer 231 may be from about 0.1 nm to about 100 μm, preferably, from about 100 nm to about 10 μm.

On the electrochromic layer 231, the electrolyte layer 232 may be provided. The electrolyte layer 232 may enclose the electrochromic layer 231.

On the electrolyte layer 232, the nanostructure 250 may be provided. The nanostructure 250 may enclose the electrolyte layer 232.

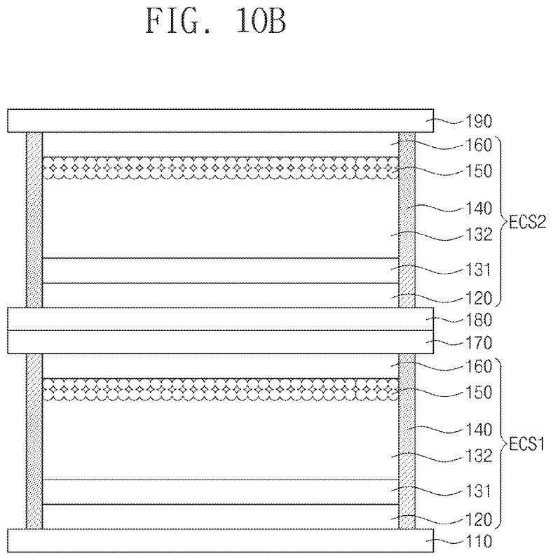

FIG. 9A and FIG. 9B are diagrams for explaining the driving of the electrochromic device according to FIG. 6.

Referring to FIG. 9, a first voltage V1 may be applied to the first electrode layer 120 and the second electrode layer 160 of the electrochromic device. The first voltage V1 may be a decolorizing voltage. In an embodiment, the first voltage V1 may be from about 0.1 V to about 5 V.

By the application of the first voltage V1, the first electrode layer 120, the electrolyte layer 132, the nanostructure 150 and the second electrode layer 160 may not be discolored in a visible light wavelength region.

By the application of the first voltage V1, the electrochromic layer 131 may become transparent. By the application of the first voltage V1, reduction reaction may be carried out in the Prussian blue or PEDOT:PSS in the electrochromic layer 131.

Referring to FIG. 9B, to the first electrode layer 120 and the second electrode layer 160 of the electrochromic device, a second voltage V2 may be applied. The second voltage V2 may be a coloring voltage. In an embodiment, the second voltage V2 may be from about −0.1 V to about −5 V.

By the application of the second voltage V2, the first electrode layer 120, the electrolyte layer 132, the nanostructure 150 and the second electrode layer 160 may not be discolored in a visible light wavelength region.

By the application of the second voltage V2, the electrochromic layer 131 may be discolored to blue. By the application of the second voltage V2, oxidation reaction may be carried out in the Prussian blue or PEDOT:PSS in the electrochromic layer 131.

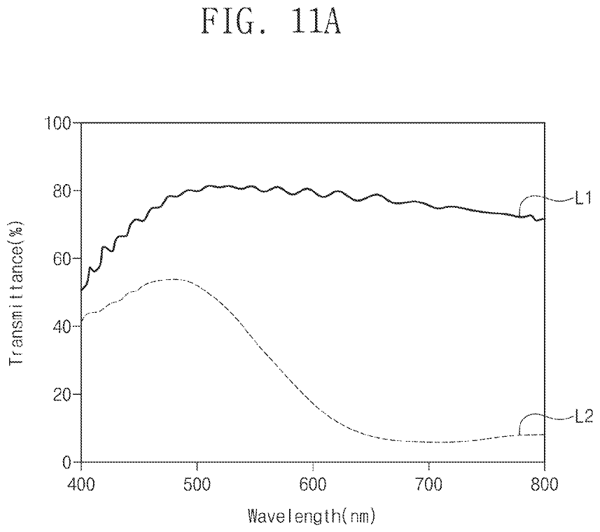

FIG. 10A and FIG. 10B are cross-sectional views of electrochromic devices according to embodiments of the inventive concept. Detailed explanation on the technical features which are overlapped with those of the electrochromic devices explained referring to FIG. 1A, FIG. 1B and FIG. 6 will be omitted, and different features therefrom will be explained in detail.

Referring to FIG. 10A, a third substrate 180 may be provided on a second substrate 170. Between first and second substrates 110 and 170, a first electrochromic structure ECS1 may be provided. Between the second and third substrates 170 and 180, a second electrochromic structure ECS2 may be provided. The first and second electrochromic structures ECS1 and ECS2 may each include a first electrode layer 120, an electrochromic layer 131, an electrolyte layer 132, a nanostructure 150, a second electrode layer 160 and a sealing part 140.

Since the electrochromic device according to this embodiment includes two electrochromic structures ECS1 and ECS2, transmittance decreasing amount due to coloring may be relatively large.

Referring to FIG. 10B, a third substrate 180 may be provided on a second substrate 170, and a fourth substrate 190 may be provided on the third substrate 180. Between first and second substrates 110 and 170, a first electrochromic structure ECS1 may be provided. Between the third and fourth substrates 180 and 190, a second electrochromic structure ECS2 may be provided. The first and second electrochromic structures ECS1 and ECS2 may each include a first electrode layer 120, an electrochromic layer 131, an electrolyte layer 132, a nanostructure 150, a second electrode layer 160 and a sealing part 140.

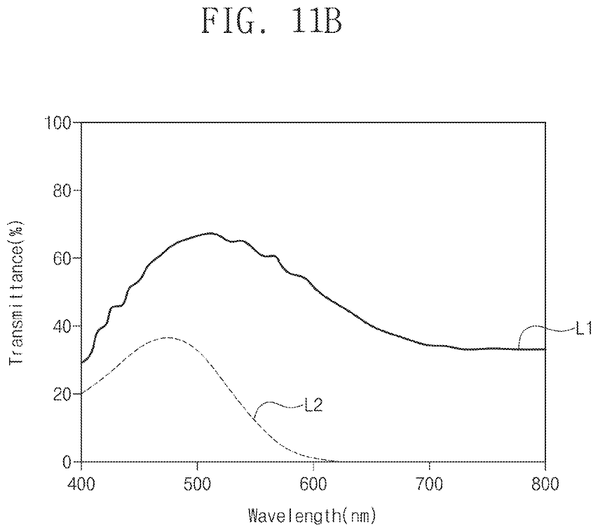

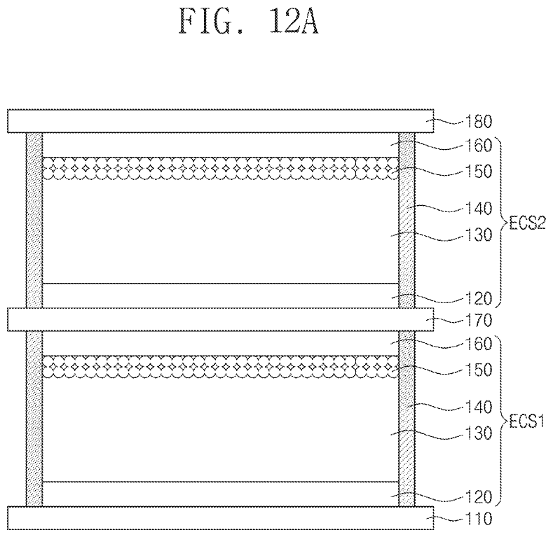

FIG. 11A is a graph showing the transmittance of an electrochromic device according to FIG. 6.

FIG. 11A shows the transmittance for a case where the first electrode layer 120 includes indium tin oxide (ITO) having resistance per unit area of about 15 ohm/cm², the second electrode layer 160 includes indium tin oxide (ITO) having resistance per unit area of about 7 ohm/cm², the electrolyte layer 132 includes about 0.2 M of lithium perchlorate (LiClO₄) and propylene carbonate (PC), and the electrochromic layer 131 has a thickness of about 400 nm and includes Prussian blue.

Referring to FIG. 11A, the transmittance in accordance with an applied voltage to an electrochromic device may be confirmed. The transmittance may be confirmed for a case where a voltage of about 1.75 V is applied to an electrochromic voltage for about 20 seconds (L1), and a case where a voltage of about −1.75 V is applied for about 20 seconds (L2).

About −1.75 V may be a coloring voltage. About 1.75 V may be a decolorizing voltage. It may be confirmed that if the coloring voltage is applied, the transmittance of the electrochromic device decreases.

FIG. 11B is a graph showing the transmittance of an electrochromic device according to FIG. 10A.

FIG. 11B shows the transmittance for a case where the first electrode layers 120 include indium tin oxide (ITO) having resistance per unit area of about 15 ohm/cm², the second electrode layers 160 include indium tin oxide (ITO) having resistance per unit area of about 7 ohm/cm², the electrolyte layers 132 include about 0.2 M of lithium perchlorate (LiClO₄) and propylene carbonate (PC), and the electrochromic layers 131 each has a thickness of about 400 nm and includes Prussian blue.

Referring to FIG. 11B, the transmittance in accordance with an applied voltage to an electrochromic device may be confirmed. The transmittance may be confirmed for a case where a voltage of about 1.75 V is applied to an electrochromic voltage for about 20 seconds (L1), and a case where a voltage of about −1.75 V is applied for about 20 seconds (L2).

About —1.75 V may be a coloring voltage. About 1.75 V may be a discoloring voltage. It may be confirmed that if the coloring voltage is applied, the transmittance of the electrochromic device decreases.

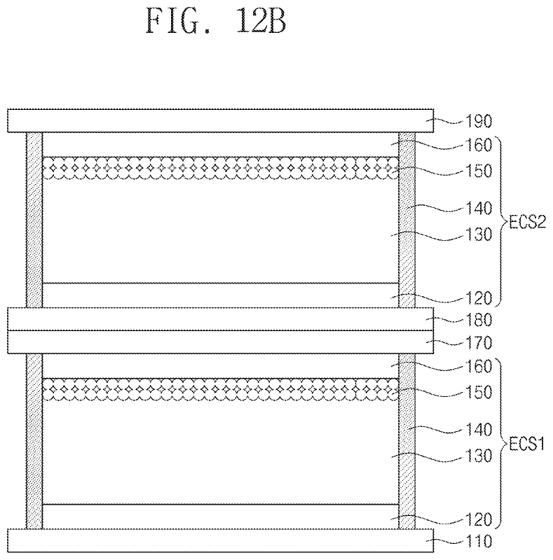

FIG. 12A and FIG. 12B are cross-sectional views of electrochromic devices according to embodiments of the inventive concept. Detailed explanation on the technical features which are overlapped with those of the electrochromic devices explained referring to FIG. 1A and FIG. 1B will be omitted, and different features therefrom will be explained in detail.

Referring to FIG. 12A, a third substrate 180 may be provided on a second substrate 170. Between first and second substrates 110 and 170, a first electrochromic structure ECS1 may be provided. Between the second and third substrates 170 and 180, a second electrochromic structure ECS2 may be provided. The first and second electrochromic structures ECS1 and ECS2 may include a first electrode layer 120, an electrochromic electrolyte layer 130, a nanostructure 150, a second electrode layer 160 and a sealing part 140, respectively.

Referring to FIG. 12B, a third substrate 180 may be provided on a second substrate 170, and a fourth substrate 190 may be provided on the third substrate 180. Between first and second substrates 110 and 170, a first electrochromic structure ECS1 may be provided. Between the third and fourth substrates 180 and 190, a second electrochromic structure ECS2 may be provided. The first and second electrochromic structures ECS1 and ECS2 may each includes a first electrode layer 120, an electrochromic electrolyte layer 130, a nanostructure 150, a second electrode layer 160 and a sealing part 140.

The electrochromic device according to the inventive concept includes a nanostructure, and may have excellent electrochromic properties.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. An electrochromic device, comprising:
a first electrode;
a second electrode on the first electrode; and
an electrochromic electrolyte layer and a nanostructure between the first and second electrodes,
wherein the nanostructure has a porous structure, and
the electrochromic electrolyte layer comprises phenothiazine or a compound represented by the following Formula 1: 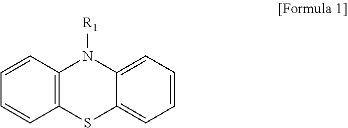
where R₁ is hydrogen, C1-C6 alkyl or phenyl.

2. The electrochromic device of claim 1, further comprising a pore in the nanostructure, and
the pore is filled with the same material included in the electrochromic electrolyte layer.

3. The electrochromic device of claim 1, wherein the compound of Formula 1 comprises one of 10-ethylphenothiazine, 10-isopropylphenothiazine, or 10-phenylphenothiazine.

4. The electrochromic device of claim 1, wherein the electrochromic electrolyte layer further comprises a polymer, a solvent and a reaction inducing material, and
the reaction inducing material comprises at least one of ferrocene, iodides, imidazole, 1,3,5-tricyanobenzene (TCB), tetracyanoquinodimethane (TCNQ), or ferrocene derivatives.

5. The electrochromic device of claim 4, wherein the polymer comprises at least one of poly(ethylene glycol) (PEG), poly methyl methacrylate (PMMA), poly butyl acrylate (PBA), poly vinyl butyrate (PVB), polyvinyl alcohol (PVA), poly(ethylene oxide) (PEO), poly(propylene oxide) (PPO), poly acrylonitrile (PAN), poly(vinylidene fluoride) (PVDF), or poly(vinylidene fluoride-co-hexafluoropropylene) (PVDF-HFP).

6. The electrochromic device of claim 5, wherein the solvent comprises at least one of propylene carbonate (PC), butylene carbonate (BC), ethylene carbonate (EC), gamma-butyrolacton (gamma-BL), gamma-VL, NMO, dimethyl carbonate (DMC), diethyl carbonate (DEC), ethyl methyl carbonate (EMC), propyl methyl carbonate (PMC), ethyl acetate (EA), water (H₂O), ethylene blue (EB) or methylene blue (MB).

7. The electrochromic device of claim 6, wherein the electrochromic electrolyte layer further comprises a lithium ion producing material, and
the lithium ion producing material comprises at least one of lithium perchlorate (LiClO₄), LiBF₄, LiPF₆, LiAsF₆, lithium triflate (LiTf, LiCF₃SO₃), lithium imdide (LiIm, Li[N(SO₂CF₃)₂]), LiBeTi (Li[N(SO₂CF₂CF₃)₂], LiBr, or LiI.

8. The electrochromic device of claim 6, wherein the electrochromic electrolyte layer further comprises a hydrogen ion producing material, and
the hydrogen ion producing material comprises at least one of hydrochloric acid (HCl), sulfuric acid (H₂SO₄), nitric acid (HNO₃), phosphoric acid (H₃PO₄), acetic acid (CH₃COOH), perchloric acid (HClO₄) or formic acid (HCOOH).

9. An electrochromic device, comprising:
a first electrode;
a second electrode on the first electrode; and
an electrochromic layer, an electrolyte layer and a nanostructure between the first and the second electrodes,
wherein the nanostructure has a porous structure, and
the electrochromic layer comprises Prussian blue or PEDOT:PSS.

10. The electrochromic device of claim 9, wherein the electrochromic layer and the nanostructure are separated by the electrolyte layer.

11. The electrochromic device of claim 9, further comprising a pore in the nanostructure, and
the pore is filled with the same material included in the electrolyte layer.

12. The electrochromic device of claim 9, wherein the electrolyte layer comprises a polymer and a solvent.

13. The electrochromic device of claim 12, wherein the polymer comprises at least one of poly(ethylene glycol) (PEG), poly methyl methacrylate (PMMA), poly butyl acrylate (PBA), poly vinyl butyrate (PVB), polyvinyl alcohol (PVA), poly(ethylene oxide) (PEO), poly(propylene oxide) (PPO), poly acrylonitrile (PAN), poly(vinylidene fluoride) (PVDF), or poly(vinylidene fluoride-co-hexafluoropropylene) (PVDF-HFP).

14. The electrochromic device of claim 13, wherein the solvent comprises at least one of propylene carbonate (PC), butylene carbonate (BC), ethylene carbonate (EC), gamma-butyrolactone (gamma-BL), gamma-VL, NMO, dimethyl carbonate (DMC), diethyl carbonate (DEC), ethyl methyl carbonate (EMC), propyl methyl carbonate (PMC), ethyl acetate (EA), water (H₂O), ethylene blue (EB) or methylene blue (MB).

15. The electrochromic device of claim 14, wherein the electrolyte layer further comprises a lithium ion producing material, and
the lithium ion producing material comprises at least one of lithium perchlorate (LiClO₄), LiBF₄, LiPF₆, LiAsF₆, lithium triflate (LiTf, LiCF₃SO₃), lithium imdide (LiIm, Li[N(SO₂CF₃)₂]), LiBeTi (Li[N(SO₂CF₂CF₃)₂]), LiBr, or LiI.

16. The electrochromic device of claim 14, wherein the electrolyte layer further comprises a hydrogen ion producing material, and
the hydrogen ion producing material comprises at least one of hydrochloric acid (HCl), sulfuric acid (H₂SO₄), nitric acid (HNO₃), phosphoric acid (H₃PO₄), acetic acid (CH₃COOH), perchloric acid (HClO₄) or formic acid (HCOOH).

17. An electrochromic device, comprising:
a first substrate;
a first electrochromic structure on the first substrate;
a second substrate on the first electrochromic structure;
a second electrochromic structure on the second substrate; and
a third substrate on the second electrochromic structure,
wherein the first and second electrochromic structures each comprises:
a first electrode, a second electrode, and a nanostructure between the first and second electrodes, and
the nanostructure has a porous structure.

18. The electrochromic device of claim 17, wherein
the first and second electrochromic structures each further comprises an electrochromic electrolyte layer on the first electrode, and
the electrochromic electrolyte layer comprises phenothiazine or a compound represented by the following Formula 1: 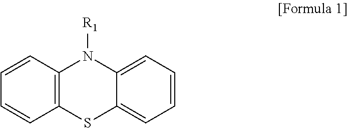
where R₁ is hydrogen, C1-C6 alkyl or phenyl.

19. The electrochromic device of claim 17, wherein
the first and second electrochromic structures each further comprises an electrochromic layer on the first electrode and an electrolyte layer on the electrochromic layer, and
the electrochromic layer comprises Prussian blue or PEDOT:PSS.
